(19) United States
(12) Patent Application Publication
(10) Pub. No.: US 2011/0167754 A1
(43) Pub. Date: Jul. 14, 2011

(54) METHOD FOR DESIGNING CONCRETE ANCHORING CONSTRUCTION ASSEMBLIES

(76) Inventors: William Dubon, Bloomingdale, IL (US); Robert Louis Turck, Highland Park, IL (US)

(21) Appl. No.: 12/684,673

(22) Filed: Jan. 8, 2010

(51) Int. Cl. G06F 17/50; E04B 1/38

(52) U.S. Cl. 52/698; 703/1

(57) ABSTRACT

A method of designing a construction assembly including an anchor fastener mounted in a concrete substrate is provided. The method includes the steps of determining a minimum required load capacity for the construction assembly, providing a graph that includes plots of load capacity versus embedment depth for one or more design parameters of interest, using the graph to select design parameters which result in a construction assembly load capacity at least as high as the minimum required load capacity, and using the selected design parameters to build the construction assembly. The graph may be generated according to standard procedures for construction assemblies that employ chemical anchoring adhesives, or according to different standard procedures for construction assemblies that employ only mechanical anchoring techniques.

### FIELD OF THE INVENTION

This invention is directed to a method of determining design strength and designing construction assemblies that include anchor fasteners in a concrete substrate, using various anchor fasteners, anchoring adhesives and embedment depths. The method is useful for selecting anchoring fasteners, anchoring adhesives and embedment depths to meet the anchoring strength requirements of specific applications.

### BACKGROUND OF THE INVENTION

Construction assemblies including anchor fasteners mounted into substrates are used in industrial and commercial construction applications such as bridges, airports, highways, skyscrapers, stadiums and tunnels. In a typical application, a borehole is drilled into a substrate member formed of concrete, steel, wood, a combination thereof, or another material. Then, the interior of the borehole can be cleaned and scrubbed to remove dust and dirt particles. Then, in some applications, the borehole is filled with a measured amount of anchoring adhesive. Then, an anchor fastener is driven or inserted into the borehole.

These construction assemblies must be designed to avoid three possible types of failure under use conditions. The first type of failure, anchor fastener failure, is illustrated in FIG. 1. The construction assembly 10 includes anchor fastener 16 driven into borehole 14 in substrate 12, and held in place with a chemical anchoring adhesive. Failure of the anchor fastener 16 occurs when the head 18 of the anchor fastener is strongly pulled in the direction of arrow 20, causing separation of the head 18 from the remainder of anchor fastener 16. Anchor fastener failure can also be called “steel failure,” representing failure of the material used to form the anchor fastener.

The second type of failure of construction assembly 10 is substrate failure, illustrated in FIG. 2. In this instance, the strong pulling of the head 18 of anchor fastener 16 in the direction of arrow 20 causes fracture, rupture and/or fragmentation of the substrate 12. FIG. 2 illustrates an example of substrate failure when the substrate 12 is concrete, and one or more fragments of the concrete breaks away. The substrate failure illustrated in FIG. 2 can also be called “concrete failure.”

The third type of failure of construction assembly 10 is borehole failure, illustrated in FIG. 3. Failure of the borehole 14 results when strong pulling of the head 18 of the anchor fastener 16 in the direction of arrow 20 causes the anchor fastener 16 to exit the borehole 14. Borehole failure may result from failure of the chemical anchoring adhesive to sufficiently anchor the anchor fastener 16 inside the borehole 14. Improper sizing of the borehole 14 relative to the anchor fastener 16 may also play a role.

In the past, a simple pullout test was sufficient to determine the capacity of the construction assembly. Usually, this capacity was determined by conducting a pull (tension) test on the anchor fastener until failure of the construction assembly. The test was performed a number of times, such as five times, and the results were averaged to determine the ultimate tension load at failure. The design capacity of the construction assembly was determined by dividing the ultimate tension load by four and comparing that number to the minimum required load capacity, thus allowing a wide safety margin. The same method was used with respect to all three types of failure described above.

One present capacity test for concrete-based construction assemblies using anchoring adhesives is American Concrete Institute (ACI) 318. This is a far more complicated test and involves the use of a complex test procedure and equations to determine whether code requirements are satisfied. For instance, the test procedure includes the steps of calculating steel strength φNₛₐ of a single anchor fastener in tension (ACI 318 D5.1.2), calculating the concrete breakout strength φN_{cb} of the anchor fastener in tension (ACI 318 D5.2.2), calculating the pullout strength of the anchor fastener in tension (ACI 318 D5.3.2), determining controlling resistance φNₙ of the anchor fastener in tension (ACI 318 D4.1.1 and D4.1.2), calculating an allowable stress design conversion factor α for loading (ACI 318, Section 9.2) and calculating an allowable stress design value using the equation T_{allowable}=φNₙ/∝. The text of ACI 318 is incorporated by reference in its entirety. The capacity test is complex and subject to errors. While software has been created to simplify the process, much effort and skill are required to finalize the design of the construction assemblies.

Alternate Criteria (AC) 308, published by the International Code Counsel (ICC), is another complicated test procedure used for concrete-based construction assemblies in which chemical anchoring adhesives are used to bond the anchor fastener inside the borehole. A similarly complicated test procedure, AC 193, is used to measure the capacity of concrete-based construction assemblies that employ non-adhesive mechanical techniques to bond the anchor fastener inside the borehole. ACI 355 is a complicated test procedure used for both mechanical and adhesive anchoring. All of these test procedures are incorporated by reference in their entireties.

There is a need or desire for a design method for anchoring fastener/concrete construction assemblies that can be readily implemented in the field without undue complexity, which satisfies the design requirements of standard test procedures such as ACI 318, AC 308, AC 193, and/or ACI 355.

### SUMMARY OF THE INVENTION

The present invention is directed to a method of determining strength design and designing construction assemblies that include an anchor fastener mounted in a concrete substrate. The method includes the steps of determining a minimum required load capacity for the construction assembly, providing a graph including plots of load capacity versus embedment depth of anchor fasteners for design parameters of interest, using the graph to select one or more design parameters that cause the construction assembly to meet or exceed the required minimum load capacity, and building the construction assembly according to the selected design parameters. The design parameters may include one or more of a) anchor fastener selection, b) concrete type, and c) chemical anchoring adhesive selection, in addition to embedment depth. When a chemical anchoring adhesive is to be used (as opposed to a non-adhesive mechanical anchoring system), the graph may include plots of load capacity versus embedment depth for different anchor fasteners, different concrete types, and different chemical anchoring adhesives. When the construction assembly employs only non-adhesive mechanical techniques for anchoring the anchor fasteners in the concrete substrate, the graph may include only plots of load capacity versus embedment depth for the anchor fasteners and concrete types of interest.

The graph may include plots of anchor fastener capacity (e.g. steel capacity), concrete capacity, and borehole capacity as a function of embedment depth. The actual load capacity of the construction assembly for a given anchor fastener and a given embedment depth is the lowest of the three. In order to properly design a construction assembly, the design parameters of anchor fastener, embedment depth and (where applicable) chemical anchoring adhesive must be selected so that the actual load capacity of the construction assembly exceeds the required minimum load capacity.

The final steps are to use the graph to select the design parameters of the construction assembly, and build the construction assembly according to the selected design parameters. By using the graph, the design parameters can be selected quickly and easily in the field without resort to complex and time consuming mathematical calculations.

With the foregoing in mind, it is a feature and advantage to provide an improved, easy to perform method of determining strength design of construction assemblies that include an anchor fastener mounted in a concrete substrate.

It is also a feature and advantage to provide a method of determining strength design that greatly reduces the potential for design errors.

These and other features and advantages will become further apparent from the following detailed description of the preferred embodiments, read in conjunction with the accompanying drawings.

### BRIEF DESCRIPTION OF THE DRAWINGS

FIG. 1 (described above) illustrates a construction assembly in which failure of the anchor fastener (steel failure) occurs during testing of load capacity.

FIG. 2 (described above) illustrates a construction assembly in which failure of the substrate (concrete failure) occurs during testing of load capacity.

FIG. 3 (described above) illustrates a construction assembly in which failure of the borehole (adhesive failure or mechanical anchoring failure) occurs during testing of load capacity.

FIG. 4 is a graph that includes plots of load capacity versus embedment depth for a plurality of design parameters for construction assemblies.

FIG. 5 is a block diagram of a data processing system useful for computer generation of a graph.

### DETAILED DESCRIPTION OF THE PREFERRED EMBODIMENTS

The present invention is directed to a method of determining strength design and designing construction assemblies that includes an anchor fastener (typically a steel anchor fastener) mounted in a concrete substrate. The construction assemblies designed by this method have load capacities that meet or exceed the requirements of standard test procedure(s) such as AC 308, ACI 318 or ACI 355 for assemblies that use chemical anchoring adhesives to mount the anchor fastener in a borehole, and AC 193 for assemblies that employ mechanical anchor fasteners without the anchoring adhesive.

The method includes the step of determining a minimum required load capacity for the construction assembly. The term “load capacity” refers to the minimum pullout or shear strength of the anchor fastener from the concrete substrate when measured using the applicable standard test procedure. For construction assemblies that use a chemical anchoring adhesive to help maintain a portion of an anchor fastener in a borehole, one present applicable test procedure for measuring load capacity is AC 308. Another applicable test procedure is ACI 318. For construction assemblies that use mechanical techniques without chemical anchoring adhesives to maintain a portion of an anchor fastener in a borehole, one present applicable test procedure for measuring load capacity is AC 193. Another test procedure, ACI 355, is presently used for both types of construction assemblies.

The method also includes the step of providing a graph including plots of load capacity versus anchor fastener embedment depth for design parameters of interest. The design parameters of interest may include one or more of a) anchor fastener selection (including diameter), b) concrete selection (including nominal compressive strength), and, when used, c) chemical anchoring adhesive selection. The graph may be generated using the test procedures provided in ACI 318, AC 308, AC 193, ACI 355, or another applicable test procedure, to ensure that construction assemblies designed using the graph meet the load capacity requirements under the applicable test procedure.

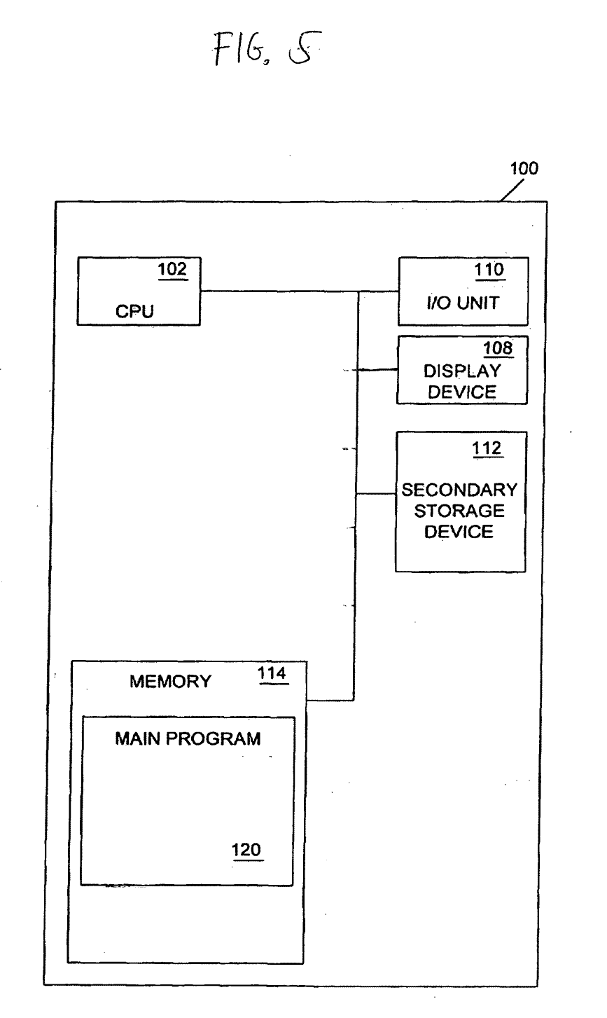

The method also includes the step of using the graph to select design parameters which result in a construction assembly having a load capacity at least as high as the required minimum load capacity. FIG. 4 is an illustrative graph that includes plots of load capacity versus anchor fastener embedment depth for various anchor fastener diameters and concrete types, using a chemical anchoring adhesive. In the illustrative example, the anchor fasteners tested are commercially available from McMaster-Carr, located in Elmhurst, Ill. The anchor fasteners were made from steel and had diameters of ⅜ inch, ½ inch, ⅝ inch, ¾ inch, ⅞ inch, 1 inch and 1¼ inches, respectively.

The concrete types tested were standard concrete types having nominal compressive strengths (determined according to ACI standards) of 2500 psi, 3000 psi, 4000 psi, 5000 psi, 6000 psi, 7000 psi, and 8000 psi respectively.

The chemical anchoring adhesive tested was an epoxy adhesive, available from Illinois Tool Works Inc., Red Head Division, located in Addison, Illinois. The chemical composition of the anchoring adhesive includes an epoxy resin and a curing agent. This chemical anchoring adhesive was tested for each of the anchor fastener diameters identified above.

Referring to FIG. 4, lines S1, S2, S3, S4, S5, S6 and S7 represent the load capacity of the steel anchor fasteners having the seven indicated diameters. In each case, the plot of load capacity versus embedment depth is a horizontal line.

The load capacity of a steel anchor fastener (i.e. the point at which steel failure, as shown in FIG. 1, occurs) is constant, and dots not vary depending on the embedment depth. This is because steel failure (as shown in FIG. 1) occurs in the portion of the anchor fastener 16 that is not embedded in the concrete substrate 12.

The load capacity for each diameter or type of anchor fastener can be determined using the procedure in ACI 318 D5.1.2, which is incorporated by reference in its entirety. According to this procedure, the nominal strength or load capacity of a single anchor or group of anchors in tension shall be governed by:

Nₛₐ=nAₛₑfᵤₜₐ
where
Nₛₐ is the nominal anchor strength,
n is the number of anchors in a group (presumed to be one for purposes of the plots in FIG. 4),
Aₛₑ is the effective cross-sectional area of the anchor, in²,
fᵤₜₐ is the specified ultimate tensile strength of the anchor steel, psi.

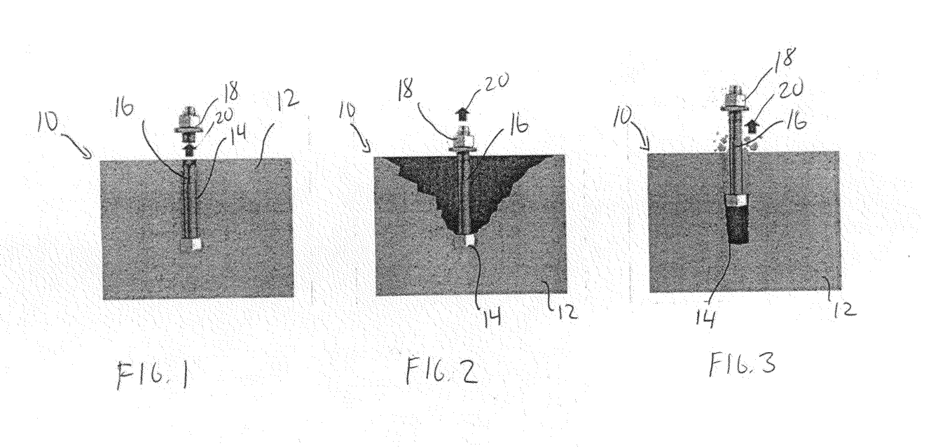

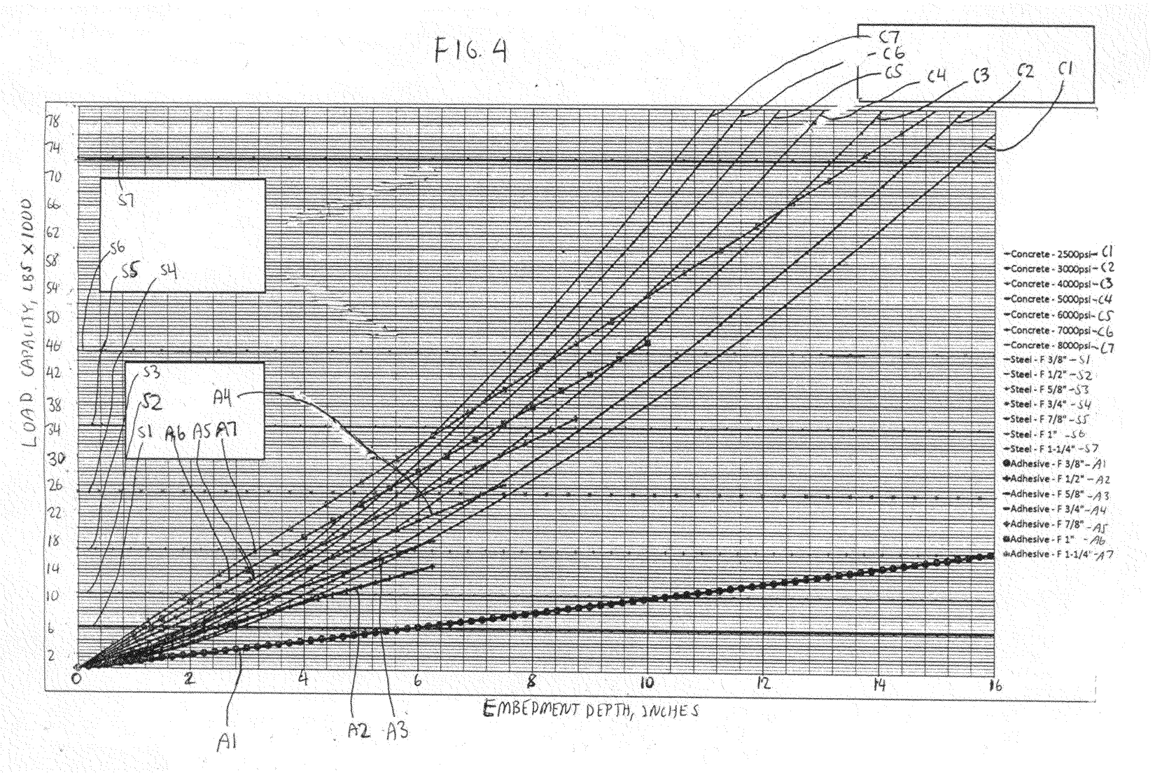

Referring again to FIG. 4, lines C1, C2, C3, C4, C5, C6 and C7 represent the load capacities of the concrete types having the seven different compressive strengths, which hold the anchor fasteners at different embedment depths. The load capacity of the concrete represents the tension load which results in failure and breakage of the concrete substrate 12, as shown in FIG. 2. The load capacity of the concrete typically increases with concrete compressive strength and/or embedment depth as shown in FIG. 4, but is not significantly dependent on anchor fastener diameter.

The load capacity of the concrete (also known as concrete breakout strength) can be determined for each type of concrete using the procedure in ACI 318 D5.2.2, which is incorporated by reference in its entirety. According to this procedure, the concrete breakout strength of a single anchor in tension in cracked concrete, Nₚ shall not exceed the following:

Nₚ=k_{c}\sqrt{f′_{c}}h_{ef}^{1.5}
where
Nₚ=basic concrete breakout strength,
k_{c}=24 for cast-in anchors
k_{c}=17 for post-installed anchors and may increase to no higher than 24 based on ACI 355.2,
f′_{c}=specified concrete compressive strength, psi, measured according to ACI 318,

h_{ef}=effective embedment depth, in., measured from the concrete surface to the deepest point on the anchor element at which bond to the concrete is established.

Referring again to FIG. 4, lines A1, A2, A3, A4, A5, A6 and A7 represent the load capacities of the borehole using the chemical anchoring adhesive identified above, for the steel anchor fasteners having the seven indicated diameters, at different embedment depths. The load capacity of the borehole is the tension load required to cause adhesive or mechanical failure between the anchor fastener 16 and the walls of the borehole 14, as shown in FIG. 3. As shown in FIG. 4, the load capacity of the borehole tends to increase with anchor fastener diameter because of the greater surface areas of bonding between higher diameter anchor fasteners and correspondingly larger boreholes. For a particular anchor fastener, greater embedment depths result in higher adhesive load capacities because of the greater surface areas of bonding.

The load capacity of the borehole (also known as pullout strength) can be determined for each diameter of anchor fastener using the procedure in ACI 318 D5.3.2, which is incorporated by reference in its entirety. According to this procedure, the pullout strength Nₚ for a particular anchor fastener is determined empirically based on a 5 percent fractile of results of tests performed and evaluated according to ACI 355.2, which is also incorporated by reference. The load capacity of the borehole will vary depending on the type of chemical anchoring adhesive and/or mechanical bond between the anchor fastener and borehole.

In order to use the graph of FIG. 4, the user must determine the minimum required load capacity of the construction assembly, and which of the design parameters are fixed and cannot be varied by the user. For example, the user in the field may not have any control over the type of concrete that forms the substrate, but may be able to select both the diameter of the anchor fastener and the anchor fastener embedment depth. Assuming a minimum required load capacity of 30,000 lbs and a concrete substrate compressive strength of 5000 psi (line C4), the user can locate the point on the graph where the line C4 intersects with a load capacity of 30,000 lbs at an embedment depth of 6.8 inches. An anchor fastener having a diameter of ⅞ inch can work for this application because the load capacity of the anchor fastener exceeds 30,000 lbs (line S5) and the borehole strength exceeds 30,000 lbs at higher embedment depths (line A5). As shown in FIG. 4, an embedment depth of at least 7.2 inches is needed in order for the ⅞ inch anchor fastener to work for this application, with this particular chemical anchoring adhesive. A larger 1-inch anchor fastener would also be suitable at the minimum embedment depth of 6.8 inches dictated by the concrete strength, because the borehole strength of the 1-inch anchor fastener (line A6) exceeds 30,000 lbs at that embedment depth. A smaller ¾ inch anchor fastener will not work for this particular application because its anchor fastener load capacity (line S4) is below 30,000 lbs. In other words, each design parameter (concrete capacity, embedment depth, anchor fastener diameter, chemical anchoring adhesive, etc.) must be selected to give a load capacity equal or greater than the minimum required load capacity of the construction assembly.

In another example, the minimum required load capacity of the construction assembly may be 40,000 lbs and, due to space limitations, the embedment depth may be limited to 8 inches. From FIG. 4, it can be seen that only concrete having a compressive strength of 6000 psi or greater (line C6) will yield a concrete substrate load capacity of 40,000 lbs or greater at that embedment depth. Only an anchor fastener having a diameter of 1¼ inches or greater will yield both an anchor fastener capacity (line S7) and a borehole capacity (line A7) of at least 40,000 lbs, at an embedment depth of 8 inches.

The next step in the method is to build the construction assembly according to the selected design parameters. In the example where the concrete substrate is fixed at 5000 psi compressive strength and the minimum required load capacity is 30,000 lbs, the user may either use a ⅞ inch anchor fastener at an embedment depth of 6.8 inch or greater, or a 1 inch anchor fastener at an embedment depth of 7.2 inch or greater. In the example where the embedment depth is limited to 8 inches and the minimum required load capacity is 40,000 lbs, the user must use concrete having a compressive strength of at least 6000 psi and an anchor fastener having a diameter of at least 1¼ inch.

The step of building the construction assembly can be performed in different ways according to how the design parameters are selected. Generally, this method step includes the step of mounting and/or inserting an anchoring fastener in a borehole in the concrete substrate. The borehole may be produced in the concrete substrate, or may be drilled in the concrete substrate using a drilling tool. If the design parameters include a selection of different anchor fasteners, or different anchor fastener diameters, then the step of building the construction assembly may include mounting a selected anchor fastener, or an anchor fastener having a selected diameter, in a borehole in the concrete substrate. The step of mounting a selected anchor fastener, or anchor fastener having a selected diameter, may further include the step of inserting the anchor fastener in a borehole in the concrete substrate to a selected embedment depth.

If the design parameters include a selection of different concrete types, or concrete having different compressive strengths, then the step of building the construction assembly may include mounting the anchor fastener in a borehole of a concrete substrate formed of a selected concrete type, or having a selected compressive strength. If the design parameters include a selection of different chemical anchoring adhesives, then the step of building the construction assembly may include the step of inserting the anchor fastener in a borehole in the concrete substrate using a selected chemical anchoring adhesive. If the construction assembly utilizes mechanical anchor fasteners, then the step of building the construction assembly may include mounting or inserting the mechanical anchor fasteners in boreholes in the concrete substrate. In all cases, the step of mounting an anchor fastener may include the step of inserting the anchor fastener in a borehole of the concrete substrate to a selected embedment depth.

The method is not limited to the graph of FIG. 4. Different graphs may be generated for different chemical anchoring adhesives, and for mechanical anchor fasteners that do not use chemical anchoring adhesives. In each case, it is important to generate the graphs and the plotted lines according to the applicable standards, currently ACI 318, AC 308 and/or ACI 355 for construction assemblies using chemical anchoring adhesives, and ACI 193 and/or ACI 355 for construction assemblies that use only mechanical anchoring techniques. While significant up-front work may be required to generate the graphs, they provide an effective, easy to use tool for the design of construction assemblies by persons in the field.

In one embodiment, a computer can be programmed and used to generate the graph or graphs showing plots of load capacity versus anchor pin embedment depth for the one or more design parameters of interest. The computer-generated graph may include plots of load capacity versus anchor pin embedment depth for a selection of different anchor fasteners, a selection of anchor fasteners having different diameters, a selection of different concrete types, a selection of concrete types having different compressive strengths, a selection of different chemical anchoring adhesives, or any design parameter of interest. The computer can be programmed using the complex mathematical equations and data required for an applicable standard procedure or procedures. One advantage of using computer-generated graphs is that the plots of load capacity versus anchor pin embedment depth are mathematically precise. Another advantage is that the plots can be generated relatively quickly. Another advantage is that the graphs can be enlarged to zoom in and focus on parts of the graph that are of interest.

FIG. 5 depicts a schematic diagram of a data processing system 100 suitable for programming and generating a graph consistent with the present invention. As shown, data processing system 100 comprises a central processing unit (CPU) 102. Data processing system 100 further comprises a display device 108, an input/output (I/O) unit 110, a secondary storage device 112, and a memory 114. The data processing system may further comprise standard input devices such as a keyboard, a mouse or a speech-processing means (each not illustrated).

Memory 114 comprises a main program 120 for generating one or more graphs in accordance with methods consistent with the present invention. The graphs would include information as described above with respect to FIG. 4, for example. Inputs are received by the program corresponding to desired design parameters as described above. Calculations are made according to the algorithms which are programmed into the computer such as the algorithms described above, and graphs are output. In an illustrative example, a graph similar to that shown in FIG. 4 may be displayed on a display screen and used or manipulated by the user.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of data processing system 100 have been described, one having skill in the art will appreciate that a data processing system suitable for use with methods, systems, and articles of manufacture consistent with the present invention may contain additional or different components.

The embodiments described herein are presently preferred. Various modifications and improvements can be made without departing from the spirit and scope of the invention. The scope of the invention is defined by the appended claims, and all changes that fall within the meaning and range of equivalents are intended to be embraced therein.

We claim:

1. A method of designing a construction assembly that includes an anchor fastener mounted in a concrete substrate, comprising the steps of:
determining a minimum required load capacity for the construction assembly;
providing a graph that includes plots of load capacity versus anchor fastener embedment depth for one or more design parameters of interest;
using the graph to select design parameters which result in a construction assembly load capacity at least as high as the minimum required load capacity; and
building the construction assembly according to the selected design parameters.

2. The method of claim 1, wherein the one or more design parameters comprises anchor fastener diameter and the step of building the construction assembly comprises mounting an anchor fastener having a selected diameter in the concrete substrate.

3. The method of claim 2, wherein the graph includes plots of anchor fastener load capacity versus anchor fastener embedment depth for a plurality of anchor fastener diameters and the step of mounting the anchor fastener further comprises inserting the anchor fastener in the concrete substrate to a selected embedment depth.

4. The method of claim 2, wherein the graph includes plots of borehole load capacity versus anchor fastener embedment depth for a plurality of anchor fastener diameters and the step of mounting the anchor fastener further comprises inserting the anchor fastener in the concrete substrate to a selected embedment depth.

5. The method of claim 1, wherein the one or more design parameters comprises concrete compressive strength and the step of building the construction assembly comprises mounting the anchor fastener in a concrete substrate having a selected compressive strength.

6. The method of claim 5, wherein the graph includes plots of concrete substrate load capacity versus anchor fastener embedment depth for a plurality of concrete types and the step of mounting the anchor fastener further comprises inserting the anchor fastener in the concrete substrate to a selected embedment depth.

7. The method of claim 1, wherein the one or more design parameters comprises anchoring adhesive type and the step of building the construction assembly comprises inserting the anchor fastener in the concrete substrate using a selected anchoring adhesive type.

8. The method of claim 1, wherein the construction assembly comprises mechanical anchor fasteners and does not include a chemical anchoring adhesive and the step of building the construction assembly comprises inserting the mechanical anchor fasteners in the concrete substrate.

9. A method of designing a construction assembly that includes an anchor fastener mounted in a concrete substrate with the aid of a chemical anchoring adhesive, comprising the steps of:
determining a minimum required load capacity for the construction assembly;
providing a graph that includes plots of load capacity versus anchor fastener embedment depth determined according to a standard procedure, for one or more design parameters of interest;
using the graph to select design parameters which result in a construction assembly load capacity at least as high as the minimum required load capacity; and
building the construction assembly according to the selected design parameters.

10. The method of claim 9, wherein the one or more design parameters comprises a selection of different anchor fasteners and the step of building the construction assembly comprises mounting a selected anchor fastener in the concrete substrate.

11. The method of claim 10, wherein the different anchor fasteners are formed of steel and vary according to anchor fastener diameter and the step of mounting the anchor fastener further comprises inserting an anchor fastener having a selected diameter in the concrete substrate.

12. The method of claim 9, wherein the one or more design parameters comprises a selection of different concrete types and the step of building the construction assembly comprises inserting the anchor fastener in a concrete substrate formed of a selected concrete type.

13. The method of claim 13, wherein the different concrete types vary according to concrete compressive strength and the step of building the construction assembly comprises mounting the anchor fastener in a concrete substrate having a selected compressive strength.

14. The method of claim 9, wherein the one or more design parameters comprises a selection of different chemical anchoring adhesives and the step of building the construction assembly comprises inserting the anchor fastener in the concrete substrate using a selected chemical anchoring adhesive.

15. A method of designing a construction assembly that includes an anchor fastener mounted in a concrete substrate, comprising the steps of:
determining a minimum required load capacity for the construction assembly;
using a computer to generate a graph that includes plots of load capacity versus anchor fastener embedment depth determined according to a standard procedure, for one or more design parameters of interest;
using the graph to select design parameters which result in a construction assembly load capacity at least as high as the minimum required load capacity; and
building the construction assembly according to the selected design parameters.

16. The method of claim 15, wherein the one or more design parameters comprises a selection of different anchor fasteners and the computer is used to generate plots of load capacity versus embedment depth for the different anchor fasteners.

17. The method of claim 15, wherein the one or more design parameters comprises a selection of different concrete types and the computer is used to generate plots of load capacity versus anchor pin embedment depth for the different concrete types.

18. A construction assembly made according to the method of claim 1.

19. A construction assembly made according to the method of claim 9.

20. A construction assembly made according to the method of claim 15.
